(19) United States
(12) Patent Application Publication
(10) Pub. No.: US 2001/0008592 A1
(43) Pub. Date: Jul. 19, 2001

(54) Toner loading apparatus

(76) Inventors: Michael Harris, Rochester, NY (US); Kevin L. Maltzahn, Webster, NY (US); Christina L. Paliouras-Pierce, Victor, NY (US); Wayne D. Fox, Macedon, NY (US); Carlton W. Campbell, Penfield, NY (US)

Correspondence Address: John E Beck, Xerox Corporation, Xerox Square 20A, Rochester, NY, 14644, US

(21) Appl. No.: 09/482,852

(22) Filed: Jan. 14, 2000

(51) Int. Cl. G03G 15/08

(52) U.S. Cl. 399/262

(57) ABSTRACT

A toner powder bottle having a base, a top, and intermediate side walls having at least one facet formed in the side wall to facilitate axial and rotational manipulation of the toner bottle to enable connection of the bottle to a bottle receiving member. Connection means cooperates with corresponding connection means of a bottle receiving member when the toner bottle is in use. A powder discharge opening formed in the base permits the flow of toner when the bottle is properly installed.

### BACKGROUND OF THE INVENTION

The present invention relates to apparatus for adding toner to the toner hopper of an electrostatic reproduction machine.

In an electrostatographic copying or printing machine using a dry toner powder, a certain amount of toner powder is consumed during use and therefore additional toner powder needs to be supplied from time to time. In many machines this is achieved by the use of a toner powder supply system which includes a replaceable toner powder bottle located in an accessible position in the machine. A typical toner powder bottle has a base, a top and intermediate side walls, and a powder discharge opening formed in the base. Bayonet connecting means on the bottle cooperate with corresponding bayonet connecting means of a bottle receiving member to which the toner bottle is connected in use. The bottle is provided with a valve having an open position allowing flow of toner powder through the powder discharge opening and a closed position preventing flow of toner powder through the powder discharge opening. Cooperating valve actuating means formed on the bottle and the receiving member actuate the valve into the open position when the bottle is connected to the receiving member and into the closed position when the bottle is disconnected from the receiving member.

When a fresh bottle is to be connected to the receiving member, it is necessary to insert the bottle axially towards the receiving member and then to rotate it by approximately 90° to cause the bayonet connection to engage. The operator achieves this by holding the bottle by its top. Similarly, when it is necessary to remove a used bottle, it must be rotated in the opposite direction to disengage the bayonet connection and then be withdrawn axially. Again the operator achieves this by holding the bottle at its top.

In the electrostatographic printing or copying machine of low or middle speed type, the toner consumption is low, so that an amount of the toner to be supplemented into the toner hopper is relatively small, requiring a toner bottle with a small capacity. Therefore, the toner use can be easily supplemented into the toner hopper by grasping the toner bottle at the top.

However, in the machine having a high printing speed, a large amount of toner has to be supplemented. For instance, it is sometimes necessary to supplement the toner more than 1.5 liters at one time. When such a large amount of the toner has to be supplemented, the toner bottle is large and heavy, so that it is difficult to apply sufficient torque to the toner bottle to install it and supplement the toner correctly into the toner hopper. Space within the machine is constrained to the extent that the operator is restricted as to where he can handle the toner bottle.

The need for the operator to handle the bottle in such manner as to provide sufficient torque to install the toner bottle necessitates a toner bottle that minimizes the operator's intrusion into the machine during installation while allowing the operator to grasp the bottle about its midsection.

The following disclosures may be relevant to certain aspects of the present invention:

U.S. Pat. No. 4,060,105 to Feldeisen et al. discloses a toner loading apparatus including a toner bottle and receiver which co-act so as to eliminate or minimize the danger of generating toner clouds or spilling toner during the loading operation. The bottle has a body and a cap rotatably mounted on one end of the body. The body has a plurality of locating and locking lugs, which co-act with corresponding channels in the receiver so that the bottle can be inserted into the receiver in only one position. As the body is rotated, the bottle is simultaneously locked onto the hopper by the lugs being moved out of alignment with their corresponding channels. After being locked onto the hopper a bellows portion of the body is compressed to expel toner into the hopper.

U.S. Pat. No. 4,615,364 to Kawata discloses a developer-supplying device including a developer hopper, a developer receptacle, and a spring-operated developer inlet cover. A bayonet type coupling member couples the receptacle to the hopper by rotation after the receptacle is installed on the hopper. A developer receptacle wall which forms the bottom of the receptacle when the latter is up-ended at the time developer is being supplied is formed on a slope to facilitate flow of the powdered developer from the receptacle, through the opening into the hopper.

U.S. Pat. No. 5,089,854 to Kaieda discloses a toner supplementing container including a toner bottle having an opening, a shutter member movable between a closed position, in which the opening of the toner bottle is closed by the shutter member, and an open position, in which the opening of the toner bottle is not closed by the shutter member, and a shutter locking member for locking the shutter member into the closed position. Also disclosed is a hopper including a locking mechanism which allows movement of the shutter member of the toner bottle into the open position only when the locking mechanism is in its locked position.

U.S. Pat. No. 5,345,297 to Katakabe et al. discloses a toner container including a toner container, a rotary shaft extending through the body of the toner container, a stirring vane fixed to one end of the rotary shaft, and a toner valve which is held in pressure contact with a seat for a toner discharge port by a compression spring, which is provided on the upper portion of the rotary shaft. As the rotary shaft is lifted, the toner valve is spaced from the seat for the toner discharge port and toner is discharged. The rotary shaft and attached stirring vane may be rotated to agitate the toner and increase toner fluidity.

U.S. Pat. No. 5,710,963 to Dirx discloses a toner powder bottle including a bayonet mount for connection to a toner hopper and finger recesses formed in the conical walls adjacent to the top to facilitate axial and rotational manipulation of the bottle, thereby enabling connection of the bottle to the toner hopper.

### SUMMARY OF THE INVENTION

Briefly stated, and in accordance with one aspect of the present invention, there is provided a toner powder bottle for supplying toner to an electrostatographic printing machine. The toner powder bottle includes a top, a base, a side wall, a powder discharge opening formed in the base, and connection means. The connection means cooperates with a corresponding connection means of a bottle receiving member to which the toner bottle is connected when in use. Facets are formed in the side wall of the toner bottle, with the facets providing flat lateral and axial function surfaces to facilitate axial and rotational manipulation of the bottle to enable connection of the bottle to the bottle receiving member.

In accordance with another aspect of the present invention, there is provided a printing machine of the type having a toner supply system. The toner supply system includes a toner powder bottle and a receiving member to which the bottle is connected when in use. The bottle includes a top, base, a powder discharge opening formed in the base, side walls, and connection means, which cooperates with corresponding connection means on the receiving member. Facets are formed in the side walls of the toner bottle, with the facets providing flat lateral and axial function surfaces to facilitate axial and rotational manipulation of the bottle.

### BRIEF DESCRIPTION OF THE DRAWINGS

Other features of the present invention will become apparent as the following description proceeds and upon reference to the drawings, in which:

FIG. 1 is an elevational view of the present invention.

FIG. 2 is an elevational view of the lower portion of the bottle and the bottle-receiving member of an electrostatographic printing machine.

FIG. 3 is a top view of the toner bottle.

FIG. 4 is an elevational view of the toner bottle in position in a printing or copying machine.

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

### DETAILED DESCRIPTION OF THE INVENTION

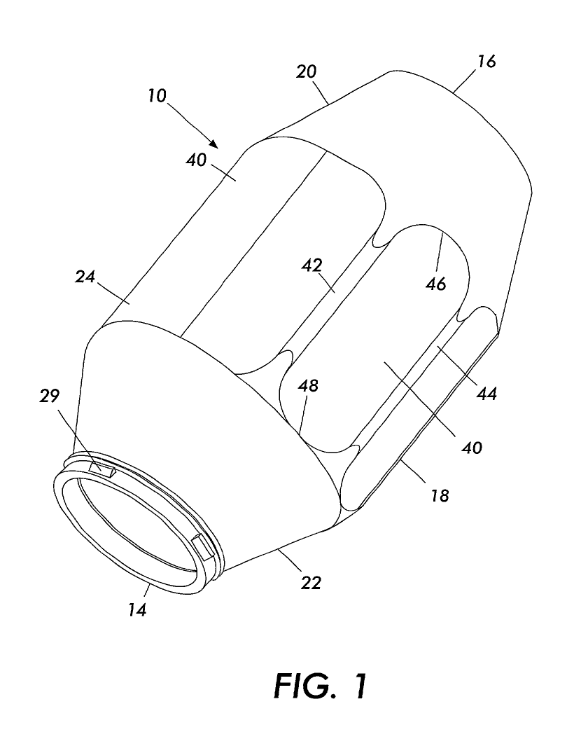

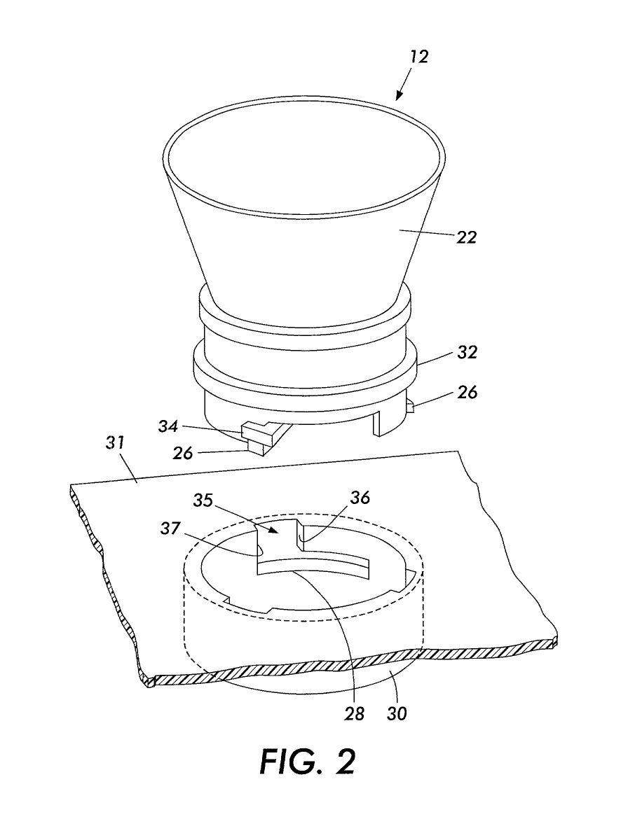

Referring to FIG. 1, there is shown the toner powder bottle 10 of the present invention. The bottle, which is formed of blow molded plastic material, has an open base 14, a closed top 16 and intermediate side walls 18. The side walls 18 are substantially free from protrusions to enable the bottle to be of the maximum possible volume to lilt within the space available within an electrostatographic copier or printer. The bottle 10 has an upper frusto-conical portion 20, a lower frusto-conical portion 22, and an intermediate portion 24. The open base 14 defines a powder discharge opening 25. The base 14 includes fixing lugs 29 to which a powder dispensing cap (not shown in FIGS. 1 and 2) is fitted.

Referring now to FIG. 2, there is shown the lower frusto-conical portion 22 of the bottle having a powder dispensing cap 32 fixed to the base of the bottle. The powder dispensing cap 32 has an open position allowing flow of toner powder through the powder discharge opening 25 and a closed position preventing flow of toner powder through the powder discharge opening 25. The powder dispensing cap is injection molded and is of a type known to the art. Also formed on the powder dispensing cap are three bayonet claws, equally angularly spaced.

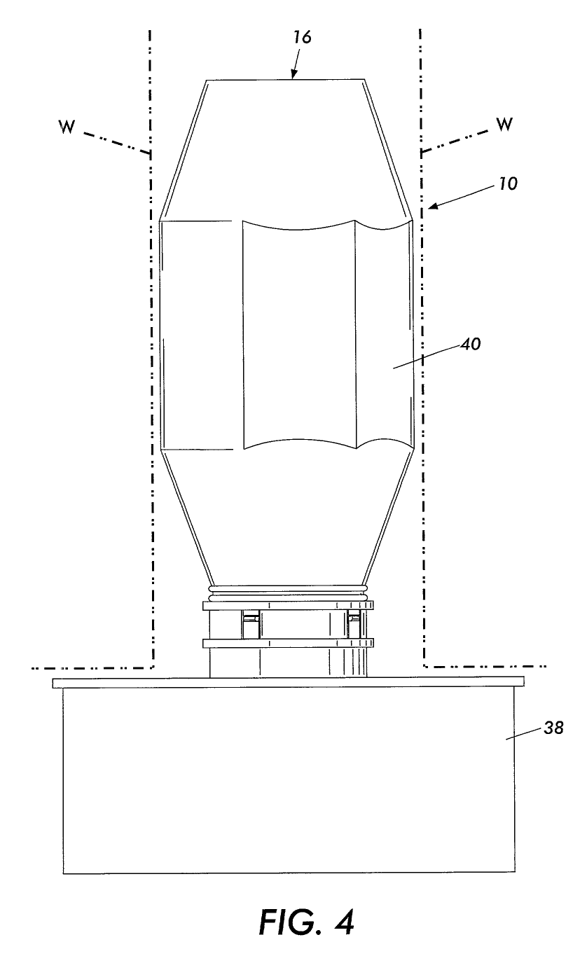

The bottle 10, together with attached powder dispensing cap 32, are connected in use to a bottle receiving member in the form of a hopper piece 30, carried on a support plate 31 of the toner hopper 38 (indicated in FIG. 4) of a copying or printing machine. The hopper piece 30 is in the form of an open cylinder having three bayonet grooves 28 formed in the walls thereof, opening via notches 35 to the upper face of the hopper piece 30. In mounting the bottle 10 in the hopper piece 30, the bayonet claws 26 co-operate with the bayonet grooves 28 formed on the hopper piece 30. Each of the notches 35 has a first side face 36, which acts upon the actuator arm 34 of the dispensing cap 32. As the bottle is rotated clockwise to engage the bayonet claws 26 in the bayonet grooves 28, the actuator arm 34 is rotated relative to the valve body causing the valve 32 to open. The bayonet connecting means 26 and the dispensing cap actuating means 34, 36 are operable by rotation of the bottle 10 through an angle of 90°. The notches 35 also each have a second side face 37, which acts upon the actuator arm 34 of the dispensing cap 32 when the bottle is rotated counter-clockwise to release the bayonet claws 26 from the bayonet grooves 28. For example when the bottle is to be replaced, the actuator arm 34 is rotated in the opposite direction relative to the dispensing cap, causing the dispensing cap 32 to close. The bottle can therefore be removed from the machine without fear of spillage of any remaining toner powder, which may remain therein.

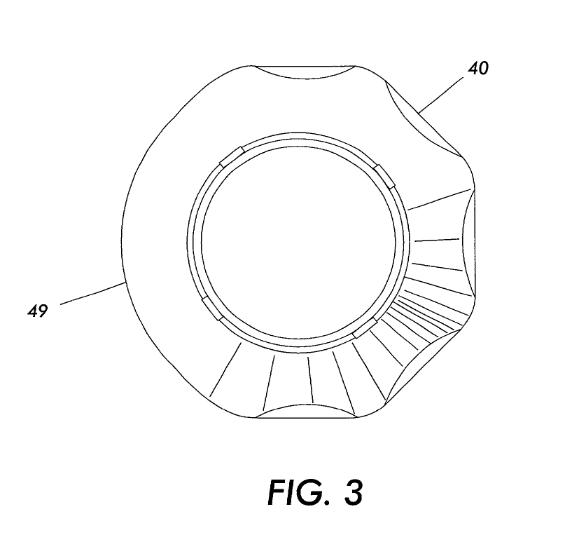

Referring now to FIG. 3, it can be seen that facets 40 are formed in the intermediate cylindrical section 24 between the upper frusto-conical portion 20 and the lower frusto-conical portion 22. Each facet 40 has a generally flat configuration, side edges 42 and 44 and top and bottom edges 46 and 48 thereof forming a flat lateral and axial function surface. The function surface facilitates axial and rotational manipulation of the bottle 10 to enable connection of the bottle 10 to the hopper piece 30. Although facets may be formed around the entire intermediate cylindrical section 24, FIG. 3 illustrates a generally curved region 49 of the intermediate cylindrical section 24 in which facets are not formed.

FIG. 4 shows the bottle 10 in position in a printing or copying machine. The dashed lines W indicate the position of adjacent walls and other components of the machine. These walls and components restrict access to the top 16 of the bottle. The provision of the facets 40 in the intermediate cylindrical section of the bottle enable the operator to insert the bottle 10 into the machine and connect it to the hopper 38, by grasping the intermediate cylindrical section and rotating the bottle 10. Manipulation of the bottle is thereby less hindered by the walls of the machine while the bottle is designed to have the maximum possible volume.

The bottle shown in the accompanying Figures holds approximately 0.8 or 1.0 kg toner powder and is used as a replacement for a conventional bottle, which held 0.8 kg powder.

What is claimed:

1. A toner powder bottle, adapted to be operatively associated with a bottle receiving member, comprising:
a top;
a base;
a side wall intermediate said top and said base, including at least one facet formed in said side wall to facilitate axial and rotational manipulation of said bottle to enable connection of said bottle to the bottle receiving member;
a powder discharge opening formed in said base; and
connecting means for cooperating with the bottle receiving member to attach the toner bottle thereto.

2. A toner bottle according to claim 1, wherein said side wall comprises a plurality of facets.

3. A toner bottle according to claim 1, wherein said side wall comprises a maximum of eight facets.

4. A toner bottle according to claim 1, wherein said side wall comprises an upper frusto-conical portion, a lower frusto-conical portion and an intermediate cylindrical portion.

5. A toner bottle according to claim 4, wherein said intermediate cylindrical portion comprises said facets.

6. A toner bottle according to claim 1, wherein said side wall interior surface comprises a shape, in the vicinity of said facet, adapted to avoid the formation of dead spaces.

7. A toner bottle according to claim 1, wherein said facet comprises:
a generally rectangular configuration;
side edges; and
top edges, said side edges and top edges defining a substantially flat lateral and axial function surface.

8. A printing machine having a toner supply system, wherein the improvement comprises:
a removable toner powder bottle, adapted to be operatively associated with a bottle receiving member, and including a base, a top, a side wall intermediate said top and said base, said side wall including at least one facet formed to facilitate axial and rotational manipulation of said bottle to enable connection of said bottle to said bottle receiving member;
a discharge opening formed in said base; and
connecting means for cooperating with said bottle receiving member to attach the toner bottle thereto.

9. A toner bottle according to claim 8, wherein said side wall comprises a plurality of facets.

10. A toner bottle according to claim 8, wherein said side wall comprises a maximum of eight facets.

11. A toner bottle according to claim 8, wherein said side wall comprises an upper frusto-conical portion, a lower frusto-conical portion and an intermediate cylindrical portion.

12. A toner bottle according to claim 11, wherein said intermediate cylindrical portion comprises said facet.

13. A toner bottle according to claim 8, wherein said side wall interior surface comprises a shape, in the vicinity of said facet, adapted to avoid the formation of dead spaces.

14. A toner bottle according to claim 8, wherein said facet comprises:
a generally rectangular configuration;
side edges; and
top edges, said side edges and top edges defining a substantially flat lateral and axial function surface.
